(19) United States
(12) Patent Application Publication
(10) Pub. No.: US 2019/0370919 A1
(43) Pub. Date: Dec. 5, 2019

(54) SYSTEMS, METHODS, AND STORAGE MEDIA FOR OPERATING AN APPLICATION ON A DISTRIBUTED COMPUTING PLATFORM FOR MANAGING RIGHTS AND ENTITLEMENTS ASSOCIATED WITH THE PRODUCTION AND DISTRIBUTION OF FILMS

(71) Applicant: Media Capital Technologies Inc., Los Angeles, CA (US)

(72) Inventors: Christopher Robert WOODROW, Los Angeles, CA (US); Kendall Blaine JOHNSTON, Venice, CA (US)

(73) Assignee: Media Capital Technologies Inc., Los Angeles, CA (US)

(21) Appl. No.: 16/428,612

(22) Filed: May 31, 2019

Related U.S. Application Data
(60) Provisional application No. 62/678,948, filed on May 31, 2018.

(51) Int. Cl. G06Q 50/18; G06F 9/455; G06Q 20/36

(52) U.S. Cl. CPC G06Q 50/184; G06Q 2220/18; G06Q 20/3678; G06F 9/45533

(57) ABSTRACT

Systems, methods, and storage media for operating an application on a distributed computing platform for managing rights and entitlements associated with the production and distribution of films are disclosed. The system may store tokenization information for a set of fungible crypto tokens on a distributed ledger, generate a set of smart contracts comprising computer instructions, and store the smart contracts on the one or more computer nodes associated with the distributed computing platform. The computing platform may execute one of the smart contracts to validate and process a request for token transfer to a digital wallet and update the distributed ledger. The computing platform may execute one of the smart contracts to determine proceeds of the films and allocate a portion of the proceeds to the tokens associated with the film.

### CROSS-REFERENCE TO RELATED APPLICATIONS

This application claims priority to U.S. Provisional Patent Application No. 62/678,948, entitled “SYSTEMS AND METHODS TO FACILITATE FINANCIAL TRANSACTIONS PERTAINING TO THE DEVELOPMENT AND CONSUMPTION OF ENTERTAINMENT ASSETS USING A DISTRIBUTED LEDGER,” filed May 31, 2018, the contents of which are incorporated herein by reference in their entirety.

### FIELD OF THE INVENTION

The present disclosure relates to systems, methods, and storage media for operating an application on a distributed computing platform for managing rights and entitlements associated with the production and distribution of films.

### BACKGROUND

The funding and profit from movies has long been a black box both for those involved, such as investors, and outsiders, such as independent film writers. For example, the production accounting may be used to skim profits intended for rights owners and the lag time from payment for licensee rights to actual receipt by the rights holder can be over a year. In addition, independent film writers have difficulty receiving funding for films despite broad fan support because they lack access to the key funding networks in Hollywood. As a result, the present system for funding movies is increasingly unwieldy in the faster-paced, modern world.

### SUMMARY

One aspect of the present disclosure relates to a system configured for operating an application on a distributed computing platform for managing rights and entitlements associated with the production and distribution of films. The distributed computing platform may include storage configured to store a distributed ledger and smart contracts may be stored on the distributed ledger. The platform may include one or more hardware processors configured by machine-readable instructions. The processor(s) may be configured to store, on the distributed ledger, tokenization information for a set of fungible crypto tokens. The crypto tokens may be associated with one or more of ownership rights pertaining to the films, intellectual property rights pertaining to the films, payment entitlement rights pertaining to the films, and/or investment rights pertaining to the films.

The distributed computing platform may include one or more computer nodes and a virtual machine which may form a runtime environment for smart contracts. The nodes may include one or more processors configured by machine-readable instructions. The processor(s) may be configured to generate a set of smart contracts including computer instructions. The processor(s) may be configured to store the smart contracts on the one or more computer nodes associated with the distributed computing platform. The computer instructions may be configured to effectuate management of the set of crypto tokens, effectuate transactions of tokens from the set of crypto tokens between participants of the distributed computing platform, effectuate distribution of proceeds of the films, and/or effectuate reporting and/or accounting pertaining to financial information regarding the films.

In one aspect of the disclosure, the processor(s) may be configured to, in response to receiving a request associated with a wallet address relating to acquisition of a subset of the tokens, execute one of the smart contracts to validate the request and assign the subset of tokens to the wallet address to effectuate the request. The processor(s) may be configured to, in response to receiving a request associated with a wallet address relating to acquisition of a subset of the tokens, update the distributed ledger to reflect an association of the subset of tokens with the wallet address. The processor(s) may be configured to, in response to determining proceeds of the films, execute a smart contract to allocate a pro rata portion of the proceeds to the tokens associated with the film.

In some implementations, the payment entitlement rights pertain to distribution of proceeds of the one or more films. Where the smart contract contemplates multiple films being funded or carry forward of profits to sequels or other projects, the smart contract may distribute proceeds or tokens from completed films in accordance with the goals of the fund as defined by the smart contract. Thus, the fund defined by the smart contract may give the public access to the film funding industry via buy in to the fund from the issuance of tokens, securities, or contractual interests.

In some implementations, the distributed computing platform may be Ethereum. In some implementations, the virtual machine may be a Turing-complete and decentralized virtual machine. In some implementations, one of the smart contracts may be programmed to prohibit the trading of an allocated token for a predetermined time after allocation. In some implementations, the method may further include the steps of determining if the predetermined time has passed, and if so, permitting trading of the allocated token on a secondary market after the predetermined time. In some implementations, the smart contract may be further configured to receive and hold in escrow amounts of a cryptocurrency. In some implementations, a set of the crypto tokens may represent rights in a set of films including the right to a pro rata portion of the proceeds of the films.

Another aspect of the present disclosure relates to a method for operating an application on a distributed computing platform for managing rights and entitlements associated with the production and distribution of films. The method may include storing on the distributed ledger tokenization information for a set of fungible crypto tokens. The virtual machine may form a runtime environment for smart contracts. The distributed computing platform may include storage configured to store the distributed ledger and the smart contracts are stored on the distributed ledger. The distributed computing platform may include one or more computer nodes. The nodes may include one or more processors configured by machine-readable instructions, the crypto tokens being associated with one or more of ownership rights pertaining to the films, intellectual property rights pertaining to the films, payment entitlement rights pertaining to the films, and/or investment rights pertaining to the films. The method may include generating a set of smart contracts including computer instructions. The computer instructions may be configured to perform one or more of effectuate management of the set of crypto tokens, effectuate transactions of tokens from the set of crypto tokens between participants of the distributed computing platform, effectuate distribution of proceeds of the films, and/or effectuate reporting and/or accounting pertaining to financial information regarding the films. The method may include storing the smart contracts on the one or more computer nodes associated with the distributed computing platform.

The method may include, in response to receiving a request associated with a wallet address relating to acquisition of a subset of the tokens, executing one of the smart contracts to validate the request and assign the subset of tokens to the wallet address to effectuate the request. The method may include, in response to receiving a request associated with a wallet address relating to acquisition of a subset of the tokens, updating the distributed ledger to reflect an association of the subset of tokens with the wallet address. The method may include, in response to determining proceeds of the films, executing a smart contract to allocate a pro rata portion of the proceeds to the tokens associated with the film.

Yet another aspect of the present disclosure relates to a non-transient computer-readable storage medium having instructions embodied thereon, the instructions being executable by one or more processors to perform a method for operating an application on a distributed computing platform for managing rights and entitlements associated with the production and distribution of films, as described further herein.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The drawings are provided for purposes of illustration only and merely depict typical or example implementations. These drawings are provided to facilitate the reader's understanding and shall not be considered limiting of the breadth, scope, or applicability of the disclosure. For clarity and ease of illustration, these drawings are not necessarily drawn to scale.

FIG. 1 illustrates a system configured for operating an application on a distributed computing platform for managing rights and entitlements associated with the production and distribution of films, in accordance with one or more implementations.

FIG. 2 illustrates a method for operating an application on a distributed computing platform for managing rights and entitlements associated with the production and distribution of films, in accordance with one or more implementations.

FIG. 3 illustrates the interaction of a system operating an application on a distributed computing platform for managing rights and entitlements, in accordance with one or more implementations.

### DETAILED DESCRIPTION

It will be appreciated by those having skill in the art that the implementations described herein may be practiced without these specific details or with an equivalent arrangement. In other instances, well-known structures and devices are shown in block diagram form in order to avoid unnecessarily obscuring the implementations of the invention.

Exemplary System Architecture

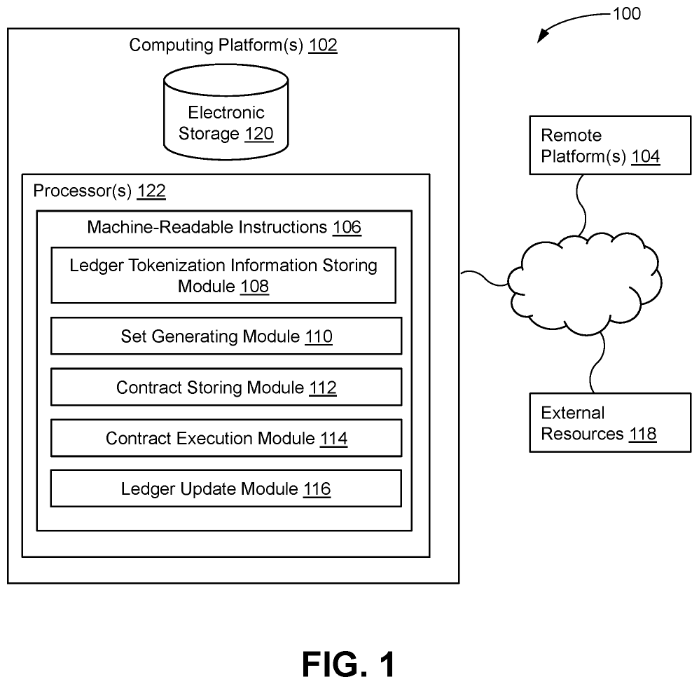

FIG. 1 illustrates a system 100 configured for operating an application on a distributed computing platform for managing rights and entitlements associated with the production and distribution of films, in accordance with one or more implementations. In some implementations, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104.

Computing platform(s) 102 may be configured by machine-readable instructions 106. Machine-readable instructions 106 may include one or more instruction modules. The instruction modules may include computer program modules. The instruction modules may include one or more of ledger tokenization information storing module 108, set generating module 110, contract storing module 112, contract execution module 114, ledger update module 116, and/or other instruction modules that program computing platform(s) 102 to perform various operations, each of which are described in greater detail herein.

Computing platform(s) 102 may comprise a virtual machine that provides a runtime environment for smart contracts and token exchange. In some implementations, the virtual machine may be a Turing-complete and/or decentralized virtual machine. Computing platform(s) 102 may include electronic storage 120 connected to processor(s) 122, the electronic storage 120 storing ledger information, smart contracts, tokens, and/or other information or objects. The instruction modules may manage the data held by the electronic storage 120.

The distributed computing platform of system 100 may include storage configured to store the distributed ledger. The smart contracts may be stored on the distributed ledger. In this aspect, the smart contracts are created in a protocol that also encompasses the tokenization of the movie assets. This protocol may be Ethereum, Neo, and/or other smart contract platforms. Accordingly, tokenization of assets, expenses, income, and rights may be controlled by the protocol through the execution of the smart contract.

The distributed ledger may support use of multiple different types of cryptocurrencies for different types of transactions and/or disbursements. The storage of records of transactions to an immutable distributed ledger may be accessible to authorized participants. The distributed computing platform may include one or more computer nodes that may include one or more processors configured by machine-readable instructions. By way of a non-limiting example, the crypto tokens may be associated with one or more of ownership rights pertaining to the films, intellectual property rights pertaining to the films, payment entitlement rights pertaining to the films, and/or investment rights pertaining to the films. The payment entitlement rights pertain to distribution of proceeds of the one or more films. The intellectual property rights pertaining to the one or more films may include one or more of patent rights, trademark rights, licensing rights, merchandising rights, and rights pertaining to derivative films that are based on the one or more films.

Ledger tokenization information storing module 108 may be configured to store on the distributed ledger tokenization information for a set of fungible crypto tokens. The set of fungible crypto tokens may relate to the fund or to a specific move. In addition, subsets of tokens may be indicated and stored on the immutable distributed ledger, each subset may be linked to specific rights, income streams, or investment levels or types. The ledger tokenization information storing module 108 may also store token owner information, past owner information, a complete history of the exchange of each token, outside (third party) related transactions, and/or other ledger information.

The set generating module 110 may be configured to generate a set of electronic smart contracts. The smart contracts generated by set generating module 110 (and/or the other smart contracts described herein) may comprise computer code configured to implement rules that control the performance of one or more operations. By way of non-limiting example, these electronic smart contracts described herein may be configured to perform one or more of: effectuate management of the set of crypto tokens; effectuate transactions of tokens from the set of crypto tokens between participants of the distributed computing platform; effectuate distribution of proceeds of the films; and/or effectuate reporting and/or accounting pertaining to financial information regarding the films. These electronic smart contracts or computer instructions may be in the form of digital or crypto tokens. The set of digital tokens may represent a smart asset or specific properties within a smart asset. A set of the crypto tokens may represent rights in a set of films including the right to a pro rata portion of the proceeds of the films. By way of non-limiting example, the financial information reported or processed by the smart contract may be related to income, expenses, and/or proceeds of the one or more films.

Contract storing module 112 may be configured to store the smart contracts on the one or more computer nodes associated with the distributed computing platform. The contract storing module 112 may be implemented on electronic storage 120 or control at least a portion of the electronic storage 120 via the execution of computer-implemented instructions on processor(s) 122. Each of the stored contracts may be related to a particular fund or may simply be a collection of unrelated contracts in similar or different protocols that are executable on the computing platform 102.

Contract execution module 114 may be configured to, in response to receiving a request associated with a wallet address relating to acquisition of a subset of the tokens, execute one of the smart contracts to validate the request and assign the subset of tokens to the wallet address to effectuate the request. The tokenization of the one or more films may be performed using a third-party proof-of-asset protocol, and/or another smart contract protocol. The one or more physical processors may be further configured by machine-readable instructions to perform the tokenization of the one or more films into the set of digital tokens as part of the contract execution.

The contract execution module 114 may read smart contracts stored in the contract storing module 112 or generated by the set generating module, or smart contract provided by remote platform(s) 104. Contract execution module 114 may be configured to, in response to determining proceeds of the films, execute a smart contract to allocate a pro rata portion of the proceeds to the tokens associated with the film. The smart contract may be further configured to receive and hold in escrow amounts of a cryptocurrency. The contract execution module 114 may be configured to, in response to a request, initiate or perform an automated audit of the tokenization, token distribution, the distributed ledger, and/or the escrow account. The contract execution module 114 may be configured to send information or requests to the ledger update module 116 and receive information from outside sources to inform allocation or payment under the smart contract.

Ledger update module 116 may be configured to, in response to receiving a request associated with a wallet address relating to acquisition of a subset of the tokens, update the distributed ledger to reflect an association of the subset of tokens with the wallet address. In various implementations, the ledger update module 116 records trades of the tokens on a trading platform or crypto exchange. Thus, the recordation and exchange of ownership rights can be more liquid and also payments to rights holders can be more immediate by reference to the distributed ledger. In cases where payment is in the form of tokens, the ledger update module 116 may record issuance of new tokens according to a smart contract or the pro rata distribution of outstanding tokens.

In some implementations, the method may further include the steps of determining if a predetermined time has elapsed, and if so, permitting trading of the allocated token on a secondary market after the predetermined time. In some implementations, different films may be grouped together as a composite set of films. In some implementations, by way of non-limiting example, ownership of the composite set of films may be tokenized into a secondary set of derivative tokens associated with one or more of ownership rights, intellectual property rights, payment entitlement rights, and/or investment rights pertaining to the composite set. In some implementations, a derivative smart contract may be generated and posted by the set generating module 110. The derivative smart contracts may be on the same blockchain but have different consensus rules, functionality (e.g. extensions to EMV and PCI interfaces), and/or underlying base tokens.

In some implementations, the derivative smart contract may be configured to effectuate management and/or transactions of the secondary set of derivative tokens, wherein a purchase of a derivative token requires an exchange of a secondary cryptocurrency or other currency. In some implementations, the disbursement of funds and/or proceeds may be strictly defined by the derivative relationships of the tokens which are encapsulated in an overarching smart contract. Likewise, funds received and kept in escrow may be defined by the derivative token relationships and definitions of the smart contracts and controlled by one or more smart contracts.

In some implementations, computing platform(s) 102, remote platform(s) 104, and/or external resources 118 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 118 may be operatively linked via some other communication media.

A given remote platform 104 may include one or more processors configured to execute computer program modules. The computer program modules may be configured to enable an expert or user associated with the given remote platform 104 to interface with system 100 and/or external resources 118, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms.

External resources 118 may include sources of information outside of system 100, external entities participating with system 100, and/or other resources. In some implementations, some or all of the functionality attributed herein to external resources 118 may be provided by resources included in system 100. Where the computing platform 102 is a virtual machine providing the runtime environment for the smart contract, the external resources 118 may include accounting software, stored monetary or crypto assets, third party interfaces, payment processors, or other inputs to the smart contracts executed on the computing platform 102.

Computing platform(s) 102 may include electronic storage 120, one or more processors 122, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 120 may comprise non-transitory storage media that electronically stores information. The electronic storage media of electronic storage 120 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 120 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 120 may include one or more virtual storage resources (e.g., cloud storage, a virtual private network, and/or other virtual storage resources). Electronic storage 120 may store software algorithms, information determined by processor(s) 122, information received from computing platform(s) 102, information received from remote platform(s) 104, and/or other information that enables computing platform(s) 102 to function as described herein.

Processor(s) 122 may be configured to provide information processing capabilities in computing platform(s) 102. As such, processor(s) 122 may include one or more of a digital processor, an analog processor, a digital circuit designed to process information, an analog circuit designed to process information, a state machine, and/or other mechanisms for electronically processing information. Although processor(s) 122 is shown in FIG. 1 as a single entity, this is for illustrative purposes only. In some implementations, processor(s) 122 may include a plurality of processing units. These processing units may be physically located within the same device, or processor(s) 122 may represent processing functionality of a plurality of devices operating in coordination.

Processor(s) 122 may be configured to execute modules 108, 110, 112, 114, and/or 116, and/or other modules. Processor(s) 122 may be configured to execute modules 108, 110, 112, 114, and/or 116, and/or other modules by software; hardware; firmware; some combination of software, hardware, and/or firmware; and/or other mechanisms for configuring processing capabilities on processor(s) 122. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, and/or 116 are illustrated in FIG. 1 as being implemented within a single processing unit, in implementations in which processor(s) 122 includes multiple processing units, one or more of modules 108, 110, 112, 114, and/or 116 may be implemented remotely from the other modules. The description of the functionality provided by the different modules 108, 110, 112, 114, and/or 116 described below is for illustrative purposes, and is not intended to be limiting, as any of modules 108, 110, 112, 114, and/or 116 may provide more or less functionality than is described. For example, one or more of modules 108, 110, 112, 114, and/or 116 may be eliminated, and some or all of its functionality may be provided by other ones of modules 108, 110, 112, 114, and/or 116. As another example, processor(s) 122 may be configured to execute one or more additional modules that may perform some or all of the functionality attributed below to one of modules 108, 110, 112, 114, and/or 116.

Exemplary Flowchart of Processes

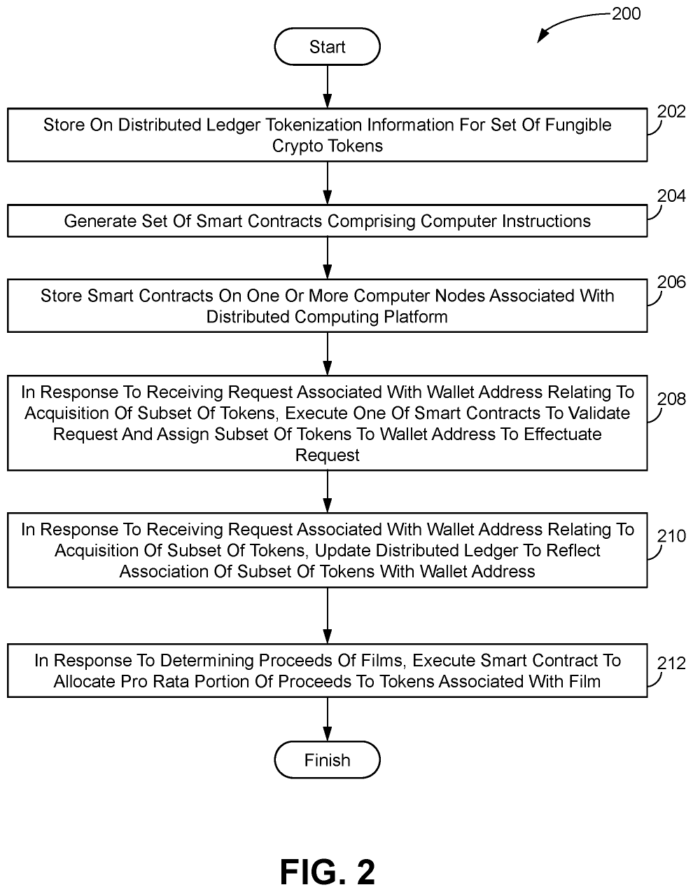

FIG. 2 illustrates a method 200 for operating an application on a distributed computing platform for managing rights and entitlements associated with the production and distribution of films, in accordance with one or more implementations. In various implementations, process 200 may be implemented via one or more smart contracts. The operations of method 200 presented below are intended to be illustrative and, as such, should not be viewed as limiting. In some implementations, method 200 may be accomplished with one or more additional operations not described, and/or without one or more of the operations discussed. In some implementations, two or more of the operations may occur substantially simultaneously. The described operations may be accomplished using some or all of the system components described in detail above.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

In an operation 202, method 200 may include storing on the distributed ledger tokenization information for a set of fungible crypto tokens. The distributed computing platform may include storage configured to store the distributed ledger and the smart contracts are stored on the distributed ledger. The distributed computing platform may include one or more computer nodes. The nodes may include one or more processors configured by machine-readable instructions, the crypto tokens being associated with one or more of ownership rights pertaining to the films, intellectual property rights pertaining to the films, payment entitlement rights pertaining to the films, and/or investment rights pertaining to the films. The fungible crypto tokens may be created upon greenlight of the film, the greenlight triggering a condition of a smart contract. In some implementations, operation 202 may be performed by a processor component the same as or similar to ledger tokenization information storing module 108 (shown in FIG. 1 and described herein).

In an operation 204, method 200 may include generating a set of smart contracts including computer instructions. The computer instructions may be configured to perform one or more of effectuate management of the set of crypto tokens, effectuate transactions of tokens from the set of crypto tokens between participants of the distributed computing platform, effectuate distribution of proceeds of the films, and/or effectuate reporting and/or accounting pertaining to financial information regarding the films. In an implementation, one of the management smart contracts may be a Proof-of-Asset protocol that automatically tokenizes received assets, register smart contract agreements, manage wallet information, dispose of assets, and connect with payment processors and terminals. In some implementations, operation 204 may be performed by a processor component the same as or similar to set generating module 110 (shown in FIG. 1 and described herein).

In an operation 206, method 200 may include storing the smart contracts on the one or more computer nodes associated with the distributed computing platform. The storing operation 206 may also involve recording the derivative connections or inter-relationships of the smart contracts. In some implementations, operation 206 may be performed by a processor component the same as or similar to contract storing module 112 (shown in FIG. 1 and described herein).

In an operation 208, method 200 may include in response to receiving a request associated with a wallet address relating to acquisition of a subset of the tokens, executing one of the smart contracts to validate the request and assign the subset of tokens to the wallet address to effectuate the request. This request authorization may be performed via public-private key matching. In some implementations, operation 208 may be performed by a processor component the same as or similar to contract execution module 114 (shown in FIG. 1 and described herein).

In an operation 210, method 200 may include in response to receiving a request associated with a wallet address relating to acquisition of a subset of the tokens, updating the distributed ledger to reflect an association of the subset of tokens with the wallet address. The wallets and subset of tokens arrangement can be used for internal accounting as well as payment of film proceeds. For example, cutting studios, subcontractors, animators, and other specialized contractors can be allocated budgets of tokens for internal accounting. Each subcontractor may have their own wallet and track costs to the production via use of the wallet. In some implementations, operation 210 may be performed by a processor component the same as or similar to ledger update module 116 (shown in FIG. 1 and described herein).

In an operation 212, method 200 may include in response to determining proceeds of the films, executing a smart contract to allocate a pro rata portion of the proceeds to the tokens associated with the film. Alternatively, in response to determining proceeds of the films, operation 212 may include executing a smart contract to allocate more tokens to participants in the distributed ledger according to various rules. In some implementations, operation 212 may be repeatedly performed as proceeds of the films are received and processed by the smart contract. In some implementations, operation 212 may be performed by a processor component the same as or similar to contract execution module 114 (shown in FIG. 1 and described herein).

Examples of smart contracts that may be executed throughout the film production life cycle include: a smart contract to attract funds and offer tokens, a smart contract investment agreement, a smart contract production financing agreement, a smart contract talent agreement, a smart contract completion bond agreement, a smart contract guild agreement, a smart contract for audit and reporting, and a smart contract collection account agreement. The smart contract collection account agreement may implement a waterfall payment plan or process where parties or token owners are given payment priorities based on a schedule in the smart contract. Such a waterfall payment plan may have the following exemplary priority structure: distributors, talent, guilds, studio, bank lenders, and equity or token investors with any additional profit being paid out to equity or token holders for the life of any income stream from the film.

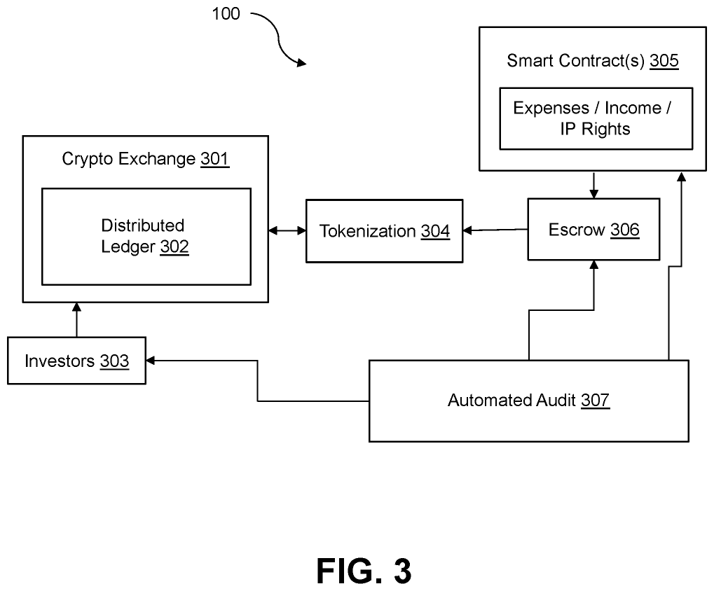

FIG. 3 illustrates an exemplary flow of information and/or tokens within a system 100 operated by smart contracts for the management of movie rights, entitlements, and expenses. The system provides a crypto exchange 301 for buying and selling between investors 303 and for issuing tokens to investors 303. The distributed ledger 302 records the ownership of the tokens by investors 303 and records additional tokenization 304 of assets being distributed from escrow 306. Smart contract(s) 305 receive and process information regarding expenses during movie production and marketing, income from various sources and licenses, and ownership of intellectual property rights. These various systems may be audited by the automated audit process 307, which accesses information on investors 303, escrow 306, and smart contract management 305.

The system 100 as a whole may be embodied in a smart contract protocol such as Ethereum or its variants (e.g. ERC-20). Thus the distributed ledger 302, the tokenization 304, escrow management 306, and related or derivative smart contracts 305 may be programmed or encoded into each token of the movie or fund of movies. Such a system provides immutability and transparency at an unprecedented level for movie funding and revenue allocation. The crypto exchange 301 may be implemented on the movie's website, on the fund's website, or on any public crypto or securities exchange.

The token issuance or tokenization 304 may be to the recorded owners in the distributed ledger based on their pro rata share of all current recorded tokens on the distributed ledger 302 corresponding to the movie asset or movie fund. The token issuance may be to the recorded owners in the distributed ledger 302 based on the pro rata share of initially-issued tokens of the movie asset or movie fund. In either case, the tokens themselves represent value to the receiving party either as cryptocurrency or as a claim to distributed assets of the fund (as distinguished from invested assets).

In a related aspect, the smart contracts 305 may be stored separately from the distributed ledger 302 and executed to manage allocation of proceeds to holders of tokens on the distributed ledger 302. In this aspect, the token ownership and exchange corresponds to partial ownership of the fund such that token holders are entitled to proceeds and proceeds are credited to token holders in fiat or other crypto currencies. The smart contracts 305 may then be implemented to manage the distribution without being an element of every token. In any case, the smart contracts and the distributed ledger are implemented in crypto protocols and may be implemented in the same crypto protocol.

Changes to the number of tokens or issuance of new tokens may require changes to the smart contract (e.g. during movie production) or the execution of conditions within the smart contract. These conditions may be budget overrun by expense inputs to the smart contract, changes in distribution contemplated by the smart contract, or other contingencies that may require more money and hence more token issuance. These conditions may trigger execution of derivative smart contracts as described previously which then may generate subsets of tokens as well as subsets of rights and obligations.

Film financing is a complex process involving numerous participants, dozens of agreements, detailed budgeting and funding processes and one or more distribution “waterfalls,” typically having anywhere from two to dozens of participants. Typically funding encompasses five main lifecycle stages: developing, financing, producing, distributing, and exploiting an entertainment asset. Each of these stages may require contingencies in the smart contract. Once an overarching smart contract is finalized each stage or contingency may trigger creation of new smart contracts or tokens.

One of the smart contracts 305 may be programmed to prohibit the trading of an allocated token for a predetermined time after allocation. In another implementation, the smart contract may be programmed to await release of the movie, a threshold amount of income, a repayment of debt, a threshold amount in escrow, or other verifiable condition before allowing trading. In another implementation, market trading of tokens and the exchange may only be generated by the smart contract system after the waterfall of contractual debts has been completed or paid. In some cases, talent, creative contributors, or subcontractors may opt to keep tokens in lieu of other payment and thus become tied to the equity or market payout of proceeds.

By way of non-limiting example, one or more smart contracts may be implemented to automate the accounting and/or reporting of income and expenses, the calculation of proceeds. The one or more smart contracts 305 may each handle income and/or expenses in related areas (e.g. foreign marketing expenses and film revenue from foreign licenses) and only feed profits into escrow 306. In this way, investors, entertainment companies, and licensees can develop a programmed smart contract to manage the allocation and reporting of income and expenses before production begins. This reduces fraud and encourages honesty upfront in the bargaining and planning process.

The automated audit 307 provides error checking by reading information from the various smart contracts 305 and distributed ledger 302 to ensure that escrow 306 and tokenization 304 are operating properly. If the smart contracts 305 and distributed ledger 302 are in the same blockchain protocol, then the automated audit 307 may simply analyze the transaction ledgers for errors. Additionally, the automated audit 307 may pull sample chains of transactions moving money or tokens across multiple smart contracts or ledgers and present them for review. The automated audit 307 may also periodically scan tokens for verification of authenticity.

Any of the elements of FIG. 2 or FIG. 3 may be implemented in hardware or as machine-readable instructions executed by a processor and causing the processor to perform various functions. Each of the elements of FIG. 3 may be implemented via a smart contract, or may represent an individual smart contract interacting with other smart contracts, or may be a condition in a smart contract, or may be a system managed by a smart contract.

For purposes of explanation, numerous specific details are set forth in order to provide a thorough understanding of the description. It will be apparent, however, to one skilled in the art that implementations of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method for managing rights and entitlements associated with the production and distribution of films, the method being implemented in a system having storage configured to store a distributed ledger and smart contracts, the system comprising a distributed computing platform that is based on the distributed ledger and supports a virtual machine that forms a runtime environment for the smart contracts, wherein the distributed computing platform includes computer nodes comprising one or more physical processors that, when configured by machine-readable instructions, perform the method, the method comprising:
storing, on the distributed ledger, tokenization information for a set of fungible crypto tokens, wherein the crypto tokens are associated with one or more of ownership rights pertaining to the films, intellectual property rights pertaining to the films, payment entitlement rights pertaining to the films, and/or investment rights pertaining to the films;
generating a set of smart contracts comprising computer code, wherein the computer code is configured to perform one or more of effectuate management of the set of crypto tokens, effectuate transactions of tokens from the set of crypto tokens between participants of the distributed computing platform, effectuate distribution of proceeds of the films, and/or effectuate reporting and/or accounting pertaining to financial information regarding the films;
storing the smart contracts on the one or more computer nodes associated with the distributed computing platform;
in response to receiving a request associated with a wallet address relating to acquisition of a subset of the tokens, executing one of the smart contracts to validate the request, assigning the subset of tokens to the wallet address to effectuate the request, and updating the distributed ledger to reflect an association of the subset of tokens with the wallet address; and
in response to determining proceeds of the films, executing a smart contract to allocate a pro rata portion of the proceeds to the tokens associated with the film.

2. The method of claim 1, wherein the payment entitlement rights pertain to distribution of proceeds of the one or more films.

3. The method of claim 1, wherein the distributed computing platform is Ethereum.

4. The method of claim 1, wherein one of the smart contracts is programmed to prohibit the trading of an allocated token for a predetermined time after allocation, the method further comprising:
determining whether the predetermined time has elapsed; and
responsive to a determination that the predetermined time has elapsed, permitting trading of the allocated token on a secondary market.

5. The method of claim 1, wherein the smart contract is further configured to receive and hold in escrow amounts of a cryptocurrency.

6. The method of claim 1, wherein a set of the crypto tokens represent rights in a set of films including the right to a pro rata portion of the proceeds of the films.

7. The method of claim 1, wherein the intellectual property rights pertaining to the one or more films include one or more of patent rights, trademark rights, licensing rights, merchandising rights, and/or rights pertaining to derivative films that are based on the one or more films.

8. The method of claim 1, wherein the financial information is related to income, expenses, and/or proceeds of the one or more films.

9. The method of claim 1, wherein different films are grouped together as a composite set of films, wherein ownership of the composite set of films is tokenized into a secondary set of derivative tokens associated with one or more of ownership rights, intellectual property rights, payment entitlement rights, and/or investment rights pertaining to the composite set, wherein a derivative smart contract is generated that is configured to effectuate management and/or transactions of the secondary set of derivative tokens, wherein a purchase of a derivative token requires an exchange of a secondary cryptocurrency.

10. The method of claim 1, wherein the distributed ledger supports use of multiple different types of cryptocurrencies for different types of transactions and/or disbursements.

11. The method of claim 1, wherein the tokenization of the one or more films is performed using a third-party proof-of-asset protocol.

12. The method of claim 1, wherein the one or more physical processors are further configured by machine-readable instructions to perform the tokenization of the one or more films into the set of digital tokens.

13. The method of claim 1, wherein one or more smart contracts are implemented to automate the accounting and/or reporting of income and expenses, the calculation of proceeds, the disbursement of funds and/or proceeds, and the storage of records of transactions to an immutable distributed ledger accessible to authorized participants.

14. A system that facilitates financial transactions pertaining to development and consumption of entertainment assets, wherein the system is implemented via a distributed computing platform that is based on a distributed ledger and supports a virtual machine that forms a runtime environment for smart contracts, wherein the distributed computing platform includes storage configured to store the distributed ledger, wherein the smart contracts are stored on the distributed ledger, the system comprising:
one or more physical processors configured by machine-readable instructions to:
obtain and/or determine information regarding tokenization of one or more entertainment assets into a set of digital tokens, wherein some or all of the set of digital tokens are stored on the distributed ledger, wherein individual digital tokens in the set of digital tokens are associated with one or more of:
(i) ownership rights pertaining to the one or more entertainment assets,
(ii) intellectual property rights pertaining to the one or more entertainment assets,
(iii) payment entitlement rights pertaining to the one or more entertainment assets, and/or
(iv) investment rights pertaining to the one or more entertainment assets; and
generate a smart contract configured to perform one or more of the following functionalities:
(i) effectuate management of the set of digital tokens for the one or more entertainment assets,
(ii) effectuate transactions of digital tokens from the set of digital tokens between participants of the distributed computing platform,
(iii) effectuate distribution of proceeds of the one or more entertainment assets, and/or
(iv) effectuate one or both of reporting and/or accounting pertaining to financial information regarding the one or more entertainment assets;
and post the smart contract to the distributed ledger; and
a computing platform associated with an investing participant, including one or more physical processors configured by machine-readable instructions to:
interact with the smart contract to purchase one or more digital tokens from the set of digital tokens for the one or more entertainment assets; and
post a record to the distributed ledger that reflects a purchase by the investing participant of the one or more digital tokens from the set of digital tokens for the one or more entertainment assets.

15. The system of claim 14, wherein one or more particular digital tokens in the set of digital tokens are associated with payment entitlement rights pertaining to the one or more entertainment assets, wherein the one or more particular digital tokens are owned by a particular participant of the distributed computing platform, wherein the one or more physical processors are further configured by machine-readable instructions to:
receive information reflecting an amount of a cryptocurrency received for access to the one or more entertainment assets; and
distribute at least a fraction of the cryptocurrency to the particular participant.

16. The system of claim 15, wherein the particular participant is an investor in the one or more entertainment assets.

17. The system of claim 15, wherein the particular participant is a creative contributor to the one or more entertainment assets.

18. The system of claim 15, wherein execution of the smart contract requires expenditure of a cryptocurrency, and wherein the cryptocurrency is hosted on the distributed ledger.

19. The system of claim 14, wherein the distributed computing platform is Ethereum.

20. The system of claim 14, wherein the smart contract is further configured to receive and hold in escrow amounts of a cryptocurrency.

21. The system of claim 14, wherein the payment entitlement rights pertain to distribution of proceeds of the one or more entertainment assets.

22. The system of claim 14, wherein the investment rights pertain to rights regarding a first offer to purchase some or all of the digital tokens or an offer to purchase some or all of the digital tokens before public participants have an opportunity to purchase any of the digital tokens.

23. The system of claim 14, wherein the intellectual property rights pertaining to the one or more entertainment assets include one or more of patent rights, trademark rights, licensing rights, merchandising rights, and rights pertaining to derivative entertainment assets that are based on the one or more entertainment assets.

24. The system of claim 14, wherein the financial information is related to income, expenses, and/or proceeds of the one or more entertainment assets.

25. The system of claim 14, wherein different entertainment assets are grouped together as a composite set of entertainment assets,
wherein ownership of the composite set of entertainment assets is tokenized into a secondary set of derivative tokens associated with one or more of ownership rights, intellectual property rights, payment entitlement rights, and/or investment rights pertaining to the composite set,
wherein a derivative smart contract may be generated and posted,
wherein the derivative smart contract is configured to effectuate management and/or transactions of the secondary set of derivative tokens,
wherein a purchase of a derivative token requires an exchange of a secondary cryptocurrency, and
wherein the secondary cryptocurrency is Smart Fund Tokens.

26. The system of claim 14, wherein the distributed ledger supports use of multiple different types of cryptocurrencies for different types of transactions and/or disbursements.

27. The system of claim 14, wherein the tokenization of the one or more entertainment assets is performed using a proof-of-asset protocol.

28. The system of claim 14, wherein the one or more physical processors are further configured by machine-readable instructions to perform the tokenization of the one or more entertainment assets into the set of digital tokens.

29. A system for managing rights and entitlements associated with the production and distribution of films, the system comprising:
a distributed computing platform supporting a virtual machine that forms a runtime environment for smart contracts, the distributed computing platform comprising one or more computer nodes and storage media configured to store a distributed ledger, the nodes comprising one or more processors configured by machine-readable instructions,
a set of crypto tokens comprising computer code, the set of crypto tokens being recorded on the distributed ledger and associated with one or more of ownership rights pertaining to the films, intellectual property rights pertaining to the films, payment entitlement rights pertaining to the films, and/or investment rights pertaining to the films; and
a set of smart contracts comprising computer code that define conditions and flows of payments, the set of smart contracts controlling allocation and transfer of the set of crypto tokens and controlling allocation and transfer of subsets of the set of crypto tokens, wherein at least one smart contract of the set of smart contracts, when executed in response to receiving proceeds of the films, allocates a pro rata portion of the proceeds to the set of crypto tokens associated with the films.

30. The system of claim 29, the system further comprising:
a digital wallet comprising computer instructions and a defined address, wherein the digital wallet is configured to store a subset of the set of crypto tokens.
